(19) United States
(12) Patent Application Publication
(10) Pub. No.: US 2017/0294070 A1
(43) Pub. Date: Oct. 12, 2017

(54) PEER COMPETITOR LOCATING SYSTEM

(71) Applicant: Nicholas A. Groetken, Plano, TX (US)

(72) Inventor: Nicholas A. Groetken, Plano, TX (US)

(21) Appl. No.: 15/249,051

(22) Filed: Aug. 26, 2016

Related U.S. Application Data
(60) Provisional application No. 62/319,970, filed on Apr. 8, 2016.

(51) Int. Cl. G07F 17/32; H04L 12/58; H04L 29/08

(52) U.S. Cl. CPC G07F 17/323; H04L 67/18; H04L 67/104; H04L 51/32; H04L 67/306; G07F 17/3244; G07F 17/3241; G07F 17/3288; G07F 17/3276

(57) ABSTRACT

The present embodiment is a system and a method for enabling interactive socialization of users at a venue and employing a wireless interactive device. The system may include a registration interface, location determination data packet, user location data packet, transmission data packet, intercommunication data packet, and mapping data packet. The registration interface may be used for registering a user or activating the system on said wireless interactive device. The location determination data packet may comprise a global positioning system. The user location data packet may be carried out by the system for checking for an active session within a venue. The transmission data packet for transmitting a notification to each user may issue a compatible match listing compatible users at the venue. The intercommunication data packet may be used for the user to receive the compatibility match notification and respond with a communications, block or ignore based on the compatible user/users located at the venue. The mapping data packet may be capable of mapping out each compatible user's location and guiding each of the users to one another.

### RELATED APPLICATION

This application claims priority to U.S. provisional patent application Ser. No. 62/319,970, filed Apr. 8, 2016. The entire contents of the provisional application referred to above is incorporated by reference.

### FEDERALLY SPONSORED RESEARCH OR DEVELOPMENT

N/A

### FIELD OF THE INVENTION

The present embodiment relates to social networking systems, and more specifically, to a peer-to-peer system for facilitating interactive socialization of users at a location or geographic radius or locus.

### BACKGROUND

Many people regularly compete in various activities, such as golf, tennis, bowling, basketball or cycling. The activity often includes friendly wagering to enhance the enjoyment and competition. However, because locating suitable competitors having a comparable skill level can be difficult, a participant is often limited to playing alone or with the same few competitors, which can be mundane. Finding suitable competition can be even more challenging if the participant has recently relocated to an area where he or she knows few people. When the competition pool is limited, the participant is in the undesirable position of competing against those with incompatible personalities or skill levels. Moreover, many athletic participants seek to broaden their competition pool beyond a regular group to vary the experience and to network or meet new people. However, finding new competition using existing techniques is usually laborious and unsuccessful.

Therefore, there is a need for a means of easily locating peer competitors for a particular activity. The present invention addresses this need by providing a software application for a portable electronic device that allows a user to enter certain personal data and search parameters in order to quickly locate and identify other competitors in a given area having similar skills.

### SUMMARY

In one embodiment, the present disclosure teaches a system for enabling interactive socialization of users at a venue and employing a wireless interactive device. The interactive device may be capable of (i) receiving and transmitting messages, (ii) accepting input through a user interface, and (iii) displaying messages on an electronic display. The system may include a registration interface, location determination data packet, user location data packet, transmission data packet, intercommunication data packet, and mapping data packet. The registration interface may be used for registering a user or activating the system on said wireless interactive device. The location determination data packet may comprise a global positioning system. The user location data packet may be carried out by the system for checking for an active session within a venue. The transmission data packet for transmitting a notification to each user may issue a compatible match listing compatible users at the venue. The intercommunication data packet may be used for the user to receive the compatibility match notification and respond with a communications, block or ignore based on the compatible user/users located at the venue. The mapping data packet may be capable of mapping out each compatible user's location and guiding each of the users to one another. The communications may include at least one of text message, phone call, a voice mail, etc.

In another embodiment, a system may be used for enabling interactive socialization users at a venue or geographic radius or locus. The system may include a network/cloud service, a registration interface for registering a user, a location determination data packet, on-location update packet, a user location data packet, data packet for running a list of active sports, transmission data packet for transmitting a notification to each user, an intercommunication data packet, and a mapping data packet. The location determination data packet may comprise a global positioning system providing a local latitude and longitude location. The on-location update data packet may be used for publishing the availability of the service. The user location data packet may be carried out by the service for checking for an active venue within a geographic region based on the location. The data packet may be used for running a list of active sports against a user compatibility engine. The transmission data packet may be used for transmitting a notification to each user that contains compatibility match listing compatible users in the venue. The intercommunication data packet may be used for the user to receive the compatibility match notification and may respond with a communications, block or ignore based on the compatible user/users located at the venue. The mapping data packet may be capable of mapping out each compatible user's location and may guide each of the users to one another. The venue may include a local radius vicinity or penumbra of the venue.

Additional features and advantages of the present disclosure will be set forth in the detailed description, which follows, and in part will be readily apparent to those skilled in the art from that description or recognized by practicing the embodiments described, including the detailed description, the claims, and the appended drawings.

It is to be understood that both the foregoing general description and the following detailed description describe various embodiments and provide an overview or framework for understanding the claimed subject. The accompanying drawings are included to provide a further understanding of the embodiments, and are incorporated into and constitute a part of this specification. The drawings illustrate the embodiments described, and with the description explain the principles and operations of the claimed subject matter.

### BRIEF DESCRIPTION OF THE DRAWINGS

The following is a description of the figures in the accompanying drawings. The figures are not necessarily to scale, and certain features and certain views of the figures may be shown exaggerated in scale or in schematic in the interest of clarity or conciseness.

FIG. 1 illustrates a basic schematic view of a platform that may be used by the system.

FIG. 2 illustrates a screen shot of a registration interface according to one exemplary embodiment.

FIG. 3 illustrates a schematic view of the exemplary method that may be used by the system.

The foregoing summary, and the following detailed description of certain inventive techniques, will be better understood when read with the figures. It should be understood that the claims are not limited to the arrangements and instrumentality in the figures. The industrial design in the figures is one of many ornamental appearances that can achieve the stated functions of the apparatus.

### DETAILED DESCRIPTION

The present disclosure can be understood more readily by reference to the following detailed description, drawings, examples, and claims, and their previous and following description. However, before the present compositions, articles, devices, and methods are disclosed and described, it is to be understood this disclosure is not limited to the compositions, articles, devices, and methods disclosed unless otherwise specified and can vary. It is also to be understood that the terminology used is to describe particular aspects only and is not intended to be limiting.

The following description of the disclosure is provided as an enabling teaching of the disclosure in certain embodiments. Those skilled in the art will recognize and appreciate that many changes can be made to the aspects of the disclosure described, while still obtaining the beneficial results of the present disclosure. It will also be apparent that some of the desired benefits of the present disclosure can be obtained by selecting some of the features of the present disclosure without utilizing other features. Those who work in the art will recognize that many modifications and adaptations to the present disclosure are possible and can even be desirable in certain circumstances and are a part of the present disclosure. The following description is provided as illustrative of the principles of the present disclosure and not in limitation thereof.

Reference will now be made to the present preferred embodiment(s), examples of which are illustrated in the accompanying drawings. Using a particular reference character in the respective views indicates the same or like parts.

Unless otherwise indicated, all numbers expressing quantities of ingredients, properties such as size, weight, reaction conditions and so forth used in the specification and claims are to be understood as modified in all instances by the term “about”. Unless indicated to the contrary, the numerical parameters in the following specification and attached claims are approximations that may vary depending upon the desired properties sought to be obtained by the invention. At the least, and not as an attempt to limit the application of the doctrine of equivalents to the claims, each numerical parameter should be construed in light of the number of reported significant digits and by applying ordinary rounding techniques, and the figures are not production drawings and should not be construed as necessarily showing all elements to scale.

Various inventive features are described below that can each be used independently of one another or in combination with other features.

Exemplary embodiments may take the form of an entire hardware embodiment, an entire software embodiment (including firmware, resident software, micro-code, etc.) or an embodiment combining software and hardware aspects that may all be referred to as a “circuit,” “module” or “system.” Exemplary embodiments may take the form of a computer program product embodied in any tangible medium of expression having computer-usable program code embodied in the medium.

Any combination of one or more computer usable or computer readable medium(s) may be utilized. The computer-usable or computer-readable medium may be but not limited to, an electronic, magnetic, optical, electromagnetic, infrared, or semiconductor system, apparatus, device, or propagation medium. More examples (a non-exhaustive list) of the computer-readable medium would include: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner and then stored in a computer memory. In this document, a computer-usable or computer-readable medium may be any medium that can contain, store, communicate, propagate, or transport the program for use by or for the instruction performance system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, and RF.

Computer program code for carrying out operations of embodiments may be written in any combination of one or more programming languages, including an object oriented programming language such as Java, Smalltalk, C++ or the like or any conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any network, including a local area network (LAN) or a wide area network (WAN), or the connection may be made to an external computer (for example, through the Internet using an Internet Service Provider).

Embodiments are described below regarding flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks. The computer program instructions may also be loaded onto a computer or other programmable data processing apparatus to cause operational steps to be performed on the computer or other programmable apparatus to produce a computer implemented process such that the instructions which execute on the computer or other programmable apparatus provide processes for implementing the functions/acts specified in the flowchart and/or block diagram block or blocks.

Broadly, the present disclosure relates to systems and methods for enabling interactive socialization of users at a location or geographic radius or locus. The system, method and device broadly includes a computer networking/cloud service that extends IT existing capabilities, in real time, over the Internet or a networking system, to users (subscription-based or pay-per-use service). More specifically, the present disclosure may relate to a peer competitor locating system that includes a software application for a portable electronic device. After entering authorization credentials, the user inputs personal profile information and preferred search parameters for locating local competitors in a desired activity. The application then generates a list of all competitors within the predefined geographical area that match the desired parameters to allow the user to arrange a contest.

The users are allowed to connect at a given location based on GPS latitude and longitude positions. Members are notified of a compatibility match at a given location or local radius via GPS latitude and longitude positioning, thereby enabling them to connect at a given location. The compatibility match may include sports compatibility match, non-sports compatibility match, age compatibility match, sex compatibility match, professional interest compatibility match. The system or application may be used in connecting with a dating, meeting, competing application for meeting others, or as a networking/socializing application for people or users with similar interests. People with similar interests can meet at a venue and compete. A friendly wager may be agreed upon, the winner may collect the winning prize.

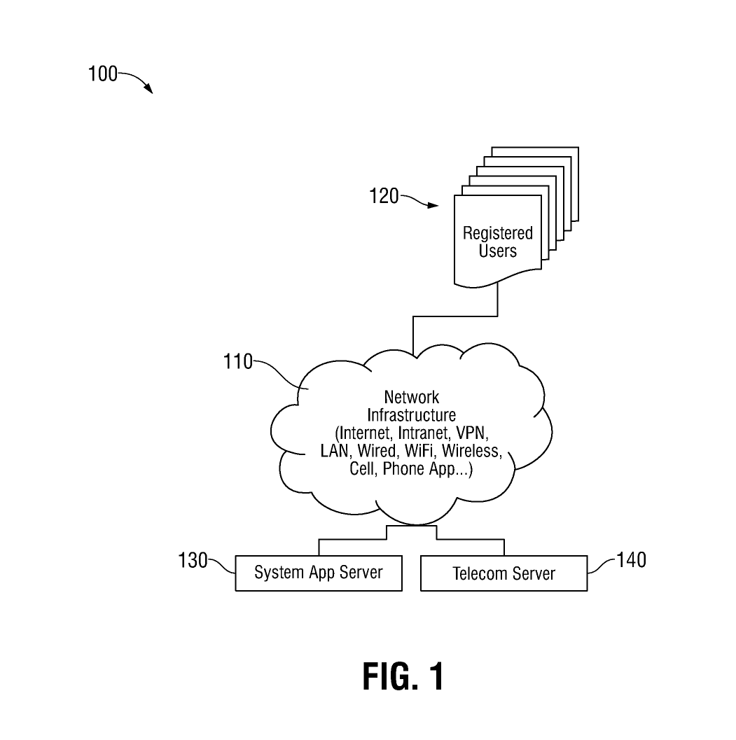

As shown in FIG. 1, a system 100 for enabling interactive socialization of users may include network/cloud service or infrastructure 110 that is configured to communicate with users 120, system app server 130 and telecom server 140. The network/cloud infrastructure 100 is achieved by means of the internet, intranet, VPN, LAN, wired, Wi-Fi, wireless, cell phone, phone App etc.

The system 100 may be provided as an application for a mobile device/a wireless interactive device capable of (i) receiving and transmitting messages, (ii) accepting input through a user interface, and (iii) displaying messages on an electronic display. The mobile device/a wireless interactive device may further include a registration interface for registering a user or activating said system on the wireless interactive device.

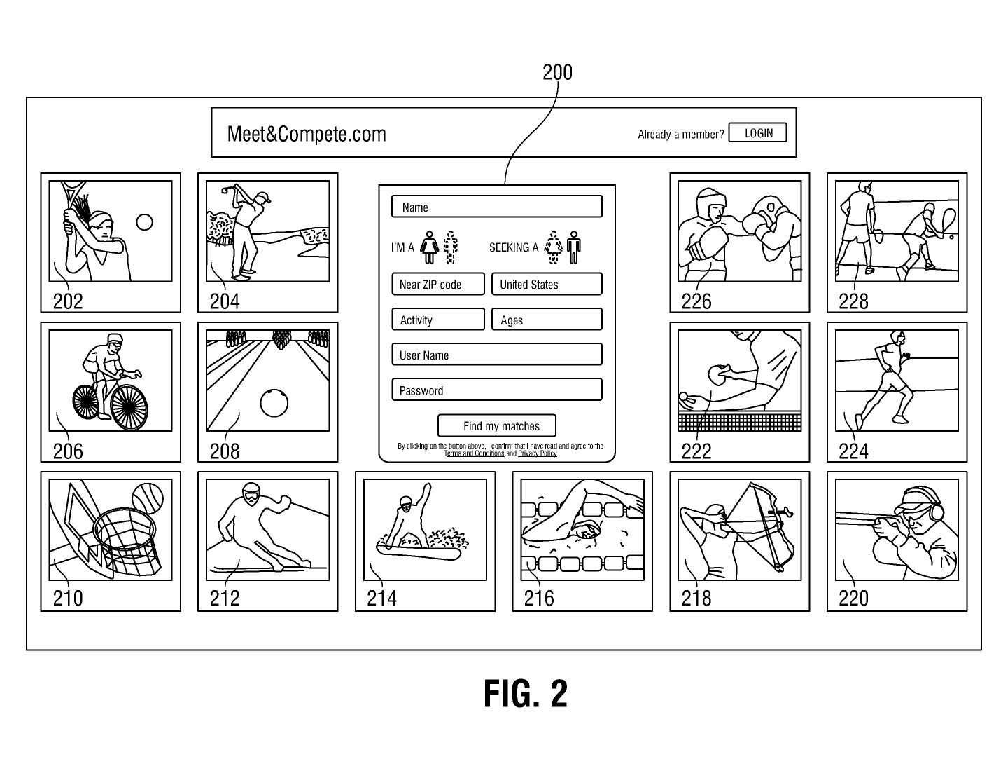

As shown in FIG. 2, in the registration interface 200, as the application is first launched, a user may be instructed to create a log in information, including a user name and password, or to log in with certain social-media credentials. Once an account is created, the user enters baseline profile information, such as name, gender, age, geographical location by inputting a zip code. The registration interface 200 may further include a plurality of sports icons, such as a tennis icon 202, a golf icon 204, a bicycle icon 206, a bowling icon 208, a basket icon 210, a skiing icon 212, a snowboarding icon 214, a swimming icon 216, a bow arrow shooting icon 218, a gun shooting icon 220, a table tennis playing icon 222, a man running icon 224, a boxing icon 226, and a squash playing icon 228.

The system 100 may further employ a laptop computer 310, or a desktop computer 330 as an alternative wireless interactive device, such as a cell phone 320. Optionally in any embodiment, the wireless interactive device includes a receiving device that receives said location of active users at a central processing station or distributed processing stations; a storage device that stores received said locations; a central processor adapted to process said locations and compare local said users compatibility data for determining said compatibility match listing; and transmission means for transmitting said compatibility match listing and location to said users within said location. Preferably, the device is appointed to be a cellular phone, smart phone, laptop, or smart pad, etc.

The system 100 may further include location determination data packet, such as a global positioning system that identifies the longitude and latitude of other users. The system further includes on-location update data packet for publishing the availability of the service at a given venue or vicinity thereof.

It is contemplated that the venue include the local vicinity of a given mile radius, depending on the type of venue. For example, in cases where the venue is a shopping mall or sporting event, the venue vicinity may include the venue's penumbra, such as a parking lot of the mall or event. During sporting events or concert events/or other entertainment events, the venue preferably includes the arena, while the vicinity includes the parking lot—so that tailgaters at the sporting event/concert event can meet through the application. The radius/vicinity can include a given radius such as, for example, 1 to 3 city blocks from one another or the like. The user location means is carried out by the system, which checks for other active sessions within the venue or vicinity. The system further includes data packet for running a list of active sessions against a user compatibility engine. The system is appointed to transmit a notification to each user upon creation of a compatibility match; the notification lists compatible users at the venue. Intercommunication packet is provided through the system/application, so that a user that receives the compatibility match notification can respond with a message, block or ignore with respect to the compatible user/users located at the venue.

The venue/location may be a public venue or a non-public venue such as a shopping mail, grocery store, sports stadium, restaurant, or nightclub, bars, casino, card rooms, bowling alleys, lawn (private or public), archery court, gyms, racquet ball court, tennis court, homes for video games, lakes, racing facilities, lumber Jack competition place, paintball place, arm wrestling place, skate boarding place, barbeque cook out competition place, dance hall, football fields, soccer fields, fishing lakes, recreation center, Frisbee golf course, chess, checkers, or any other board games, a golf course, a shooting range, a tennis court, a swimming pool, a ski resort, a bowling alley, pool house, or race track, basketball court, volleyball court, hobbyist location, non-hobbyist location, amateur sports location, and non-amateur sports location. The location or other niche locations are also provided, including churches, religious locations, tourist locations, sport locations, and/or professional meeting locations. The venue includes a local radius vicinity or penumbra of the venue. The vicinity may include a mile radius around an event/venue, and may include a parking lot around a venue, or the like. The system may further be integrated within the venue location network wherein a user can respond to a local compatibility match user by initiating a message through the venue itself. For example, where the venue is a bar or restaurant, the user can send a message to the venue location network to buy a drink or have a drink/message/delivered over to the compatible local user by way of a waiter/waitress at the venue.

The system may further include mapping data packet/guidance technology 340 of the type provided through known mapping systems 350 (Le. such as Google Maps®) so that the application of the system maps out each compatible user's location and guides each of the users to one another.

Activation of the system/application on the wireless device may be automatic based on the venue and/or location of the user. For example, if the venue is a bar/restaurant, when a user walks through the door, the application in the wireless device can automatically become activated/or a prompt for activation may be transmitted to the wireless device or phone. In this manner, the user can then automatically be notified when other compatible users are local. Alternatively, rather than automatic activation, the user must initialize the system for activating the system on the wireless interactive device.

The user compatibility engine may preferably include compatibility data comprising sex, age, age range, left handed, right handed, interests, professional interests, hobbies, relationship status, physical attributes, physical activity level and/or sport team interests, social interests, and/or a skill set level (such as a low, medium, and high level). Preferably, the compatibility match listing that is issued to each of said users in said location includes a compatibility rating score. If said compatibility rating score is less than a given score, such as from about 35% to about 75%, said users are not notified of each other's locations. Preferably, where the users have a significant number of matching criteria and/or hobbies or interests, or personality traits, the compatibility rating score may be provided as a numerical rating ranging between 85%-100%. Where the compatibility rating is somewhat less of a match, but includes some matching criteria, the numerical rating may be provided as a numerical rating ranging between 70%-84%. Less compatibility may be provided as a numerical rating ranging on a sliding scale of 55%-69%; 40-54%; 25%-39%; and 1%-25%. The users can then decide if they would like to reach out to the other user. If one of the users blocks or declines the notification request, the other user will not be directed to the direct position and location of the user. Only if both users accept the notification will each user be notified as to the exact location and profile/information attending to the other user, respectively. Optionally, a user may elect to only be notified of matches within or above a given range or compatibility match rating. For example, a user may specify that he/she only wants notifications relating to another user who is rated as an 85%-100% match.

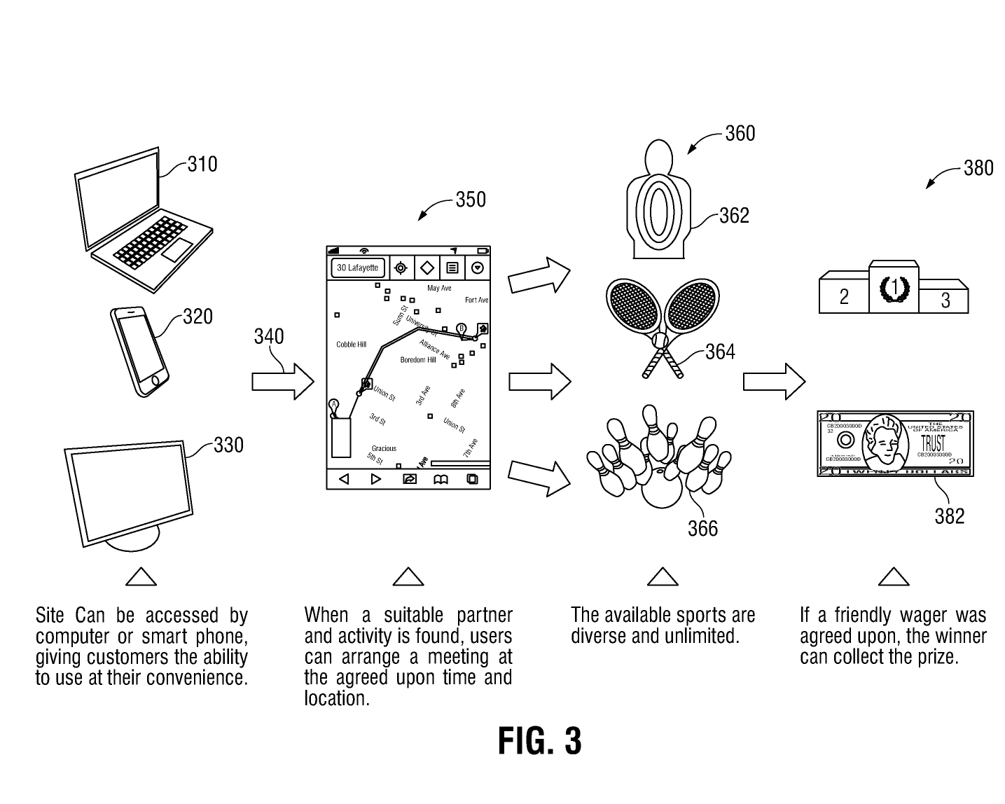

Still in FIG. 3, a user registers through the registration interface on the laptop computer 310, a wireless device 320, or a desktop computer 330. User information provided during registration may include likes and dislikes, interests, personality types, and dating preferences. User register information is stored in system database. In application generally, the user initializes the social system when physically present at a location. Initialization may include notifying the system that the user is actively seeking other users at the location or within a nearby vicinity thereof. Note that initialization may be automatic, without the need for the user to have to notify the application. GPS or other location determination or mapping data packet 340 may be activated to lock in user's location. GPS or other locating means are activated to search for other users in the location or vicinity.

The system uses mapping data packet 350 to determine if other users match or correlate to the user's information. A user is notified of other users in the location/vicinity that match the user's information. Non-matching users can also be listed or provided to the user. All local users are notified of activation and match or notification. Each user is provided an option to accept/decline further information dissemination. If users select accept, the users' exact location will be provided and/or other direct contact information may be provided so that the users can meet. The mapping data packet 350 can map out each compatible user's location and guide each of the users to one another.

Through use of the subject system/application, users/members at a public establishment, such as a restaurant, shopping mall or the like, can meet. Using the subject system/application, users or members can enroll in the program to meet other users/members with similar interests. During enrollment, users enter information into an application to provide user profile information, which may include interest, personality information, hobbies, and/or status (single, etc.). After completing the application, the program stores user profile information for matching users and determining compatibility. In order to meet another user at a public establishment that is a participant in the program, a user signs into the program. The program then computes the user's coordinates and advises the user of others in the immediate vicinity and alerts the user and/or other users in the vicinity. This process facilitates meetings between program participants.

The subject system/application provides a peer-to-peer system for enabling interactive socialization of users at a location or geographic radius or locus; such system/application, as herein described, can be modified in numerous ways without departing from the scope of the invention. Optional platform technology can be utilized to equip the peer-to-peer system for enabling interactive socialization properties.

The available sports 360 can be diverse and unlimited. The available sports 360 may include shooting 362, tennis 364, or bowling 366. The system 100 may further include a gaming account 380 allowing users to place a wager 382, to collect wager 382, to collect winnings by placing a successful wager 382. The system 100 can include a user payment system. The user payment may include at least one of a credit card account, a PayPal account, an apple pay account, a bank account, a bitcoin account or derivative thereof. The system 100 may further include a wager system so that users could place a wager 382 in the wager system. Suitable partners can place a friendly wager before participating a sports activity, after the competition, the winner may collect the prize from the gaming account.

It should be understood that the foregoing description relates to exemplary embodiments of the invention and that modifications may be made without departing from the spirit and scope of the invention as set forth in the following claims.

The claims appended hereto should be taken as the sole representation of the breadth of the present disclosure and the corresponding scope of the various embodiments described herein. Further, it will be apparent that modifications and variations are possible without departing from the scope of the invention defined in the appended claims. More specifically, although some aspects of the present disclosure are identified herein as preferred or particularly advantageous, it is contemplated that the present disclosure is not necessarily limited to these aspects.

It is noted that one or more of the following claims utilize the term “wherein” as a transitional phrase. For the purposes of defining the present disclosure, it is noted that this term is introduced in the claims as an open-ended transitional phrase that is used to introduce a recitation of a series of characteristics of the structure and should be interpreted in like manner as the more commonly used open-ended preamble term “comprising.”

It is also noted that recitations herein of “at least one” component, element, etc., should not be used to create an inference that the alternative use of the articles “a” or “an” should be limited to a single component, element, etc.

It is further noted that recitations herein of a component of the present disclosure being “configured” in a particular way, to embody a particular property, or to function in a particular manner, are structural recitations, as opposed to recitations of intended use. More specifically, the references herein to the manner in which a component is “configured” denotes an existing physical condition of the component and, as such, is to be taken as a definite recitation of the structural characteristics of the component.

It is noted that terms like “preferably,” “commonly,” and “typically,” when utilized herein, are not utilized to limit the scope of the claimed invention or to imply that certain features are critical, essential, or even important to the structure or function of the claimed invention. Rather, these terms are merely intended to identify particular aspects of an embodiment of the present disclosure or to emphasize alternative or additional features that may or may not be utilized in a particular embodiment of the present disclosure.

In this disclosure, it is noted that the terms “substantially” and “approximately” are utilized herein to represent the inherent degree of uncertainty that may be attributed to any quantitative comparison, value, measurement, or other representation. The terms “substantially” and “approximately” are also utilized herein to represent the degree by which a quantitative representation may vary from a stated reference without resulting in a change in the basic function of the subject matter at issue.

While the invention has been described with respect to a limited number of embodiments, those skilled in the art, having benefit of this disclosure, will appreciate that other embodiments can be devised that do not depart from the scope of the invention as disclosed herein. Accordingly, the scope of the invention should be limited only by the attached claims.

1. A system for enabling interactive socialization of users at a venue and employing a wireless interactive device capable of (i) receiving and transmitting messages, (ii) accepting input through a user interface, and (iii) displaying messages on an electronic display, the system comprising:
a. a registration interface for registering a user or activating said system on said wireless interactive device;
b. location determination data packet comprising a global positioning system;
c. user location data packet carried out by said system for checking for an active session within a venue;
d. transmission data packet for transmitting a notification to each user issuing a compatible match listing compatible users at said venue;
e. intercommunication data packet wherein said user receives said compatibility match notification and respond with a communications, block or ignore based on the compatible user/users located at said venue; and
f. mapping data packet capable of mapping out each compatible user's location and guiding each of said users to one another.

2. The system for enabling interactive socialization of users at a venue as recited by claim 1, wherein said wireless interactive device includes a receiving device that receives said locations of active users at a central processing station or distributed processing stations.

3. The system for enabling interactive socialization of users at a venue as recited by claim 2, wherein said wireless interactive device further includes a storage device that stores said received locations.

4. The system for enabling interactive socialization of users at a venue as recited by claim 1, wherein said wireless interactive device further includes a central processor adapted to process said locations and compare local said user's compatibility data for determining said compatibility match listing.

5. The system for enabling interactive socialization of users at a venue as recited by claim 1, wherein said transmission data packet further transmits said compatibility match listing and said locations to said users within said venue.

6. The system for enabling interactive socialization of users at a venue as recited by claim 1, wherein said venue is at least one of a public venue or a non-public venue such as bars, casino, card rooms, bowling alleys, lawn (private or public), archery court, gyms, racquet ball court, tennis court, homes for video games, lakes, racing facilities, lumber Jack competition place, paintball place, arm wrestling place, skate boarding place, barbeque cook out competition place, dance hall, football fields, soccer fields, fishing lakes, recreation center, Frisbee golf course, chess, checkers, or any other board games, a golf course, a shooting range, a tennis court, a swimming pool, a ski resort, a bowling alley, pool house, or race track, basketball court, volleyball court, hobbyist location, non-hobbyist location, amateur sports location, and non-amateur sports location.

7. The system for enabling interactive socialization of users at a venue as recited by claim 1, wherein said venue is based on a group or niche location, such as a sports venue, non-sports venue, or professional meeting or conference.

8. The system for enabling interactive socialization of users at a venue as recited by claim 1, wherein said activating said system on said wireless interactive device is automatic, based on said venue and/or location of said user.

9. The system for enabling interactive socialization of users at a venue as recited by claim 1, wherein said user compatibility engine includes compatibility data comprising sex, age, age range, left handed, right handed, interests, professional interests, hobbies, relationship status, physical attributes, physical activity level, sports team interests, social interests, and/or a skill set level (such as a low, medium, and high level).

10. The system for enabling interactive socialization of users at a venue as recited by claim 1, wherein said compatibility match listing that is issued to each of said users in said venue includes a compatibility rating score based on an attribute of sex, age, age range, interests, professional interests, left handed, right handed, hobbies, relationship status, physical attributes, physical activity level, sport team interests, social interests, and/or a skill set level (such as a low, medium, and high level).

11. The system for enabling interactive socialization of users at a venue as recited by claim 10, wherein if said compatibility rating score is less than a given score, such as from about 35% to about 75%, said users are not notified of each other's locations.

12. The system for enabling interactive socialization of users at a venue as recited by claim 1, wherein said system is integrated within said venue and said user can respond with a communications to said compatible user through said venue.

13. The system for enabling interactive socialization of users at a venue as recited by claim 1, wherein said user initializes said system for activating said system on said wireless interactive device.

14. The system for enabling interactive socialization of users at a venue as recited by claim 1 further comprising a gaming account allowing users to place a wager, to collect winnings by placing a successful wager, or to recover payment from unsuccessful wager.

15. The system for enabling interactive socialization of users at a venue as recited by claim 1 further comprising a user payment system, wherein the user payment includes at least one of a credit card account, a PayPal account, an apple pay account, a bank account, a bitcoin account, or derivative thereof.

16. The system for enabling interactive socialization of users at a venue as recited by claim 1 further comprising a wager system wherein users place a wager in the wager system.

17. The system for enabling interactive socialization of users at a venue as recited by claim 1, wherein the communications includes at least one of text message, phone call, a voice mail, etc.

18. The system for enabling interactive socialization of users at a venue as recited by claim 1, wherein the compatibility match includes sports compatibility match, non-sports compatibility match, age compatibility match, sex compatibility match, professional interest compatibility match.

19. A system for enabling interactive socialization of users at a venue or geographic radius or locus, comprising:
a. a network/cloud service;
b. registration interface for registering a user;
c. location determination data packet comprising a global positioning system providing a local latitude and longitude location;
d. on-location update data packet for publishing the availability of the service;
e. user location data packet carried out by the service for checking for an active venue within a geographic region based on the location;
f. data packet for running a list of active sports against a user compatibility engine;
g. transmission data packet for transmitting a notification to each user that contains compatibility match listing compatible users in the venue;
h. intercommunication data packet wherein the user receives the compatibility match notification and can respond with a communications, block or ignore based on the compatible user/users located at the venue; and
i. mapping data packet capable of mapping out each compatible user's location and guiding each of said users to one another; wherein said venue including a local radius vicinity or penumbra of said venue.

20. The system for enabling interactive socialization of users at a venue as recited by claim 19, wherein said transmission data packet further transmits said compatibility match listing and said locations to said users within said venue.

21. The system for enabling interactive socialization of users at a venue as recited by claim 19, wherein said venue is at least one of a public venue or a non-public venue such as bars, casino, card rooms, bowling alleys, lawn (private or public), archery court, gyms, racquet ball court, tennis court, homes for video games, lakes, racing facilities, lumber Jack competition place, paintball place, arm wrestling place, skate boarding place, barbeque cook out competition place, dance hall, football fields, soccer fields, fishing lakes, recreation center, Frisbee golf course, chess, checkers, or any other board games, a golf course, a shooting range, a tennis court, a swimming pool, a ski resort, a bowling alley, pool house, or race track, basketball court, volleyball court, hobbyist location, non-hobbyist location, amateur sports location, and non-amateur sports location.

22. The system for enabling interactive socialization of users at a venue as recited by claim 19, wherein said venue is based on a group or niche location, such as a sports venue, non-sports venue, or professional meeting or conference.

23. The system for enabling interactive socialization of users at a venue as recited by claim 19, wherein said user compatibility engine includes compatibility data comprising sex, age, age range, left handed, right handed, interests, professional interests, hobbies, relationship status, physical attributes, physical activity level, sport team interests, social interests, and/or skill set level (such as a low, medium, and high level).

24. The system for enabling interactive socialization of users at a venue as recited by claim 19, wherein said compatibility match listing that is issued to each of said users in said venue includes a compatibility rating score.

25. The system for enabling interactive socialization of users at a venue as recited by claim 19, wherein if said compatibility rating score is less than a given score, such as from about 35% to about 75%, said users are not notified of each other's locations.

26. The system for enabling interactive socialization of users at a venue as recited by claim 19, wherein said system is integrated within said venue and said user can respond with a communications to said compatible user through said venue.

27. The system for enabling interactive socialization of users at a venue as recited by claim 19 further comprising a gaming account allowing users to place a wager, collect winnings by placing a successful wager, or recover payment from unsuccessful wager.

28. The system for enabling interactive socialization of users at a venue as recited by claim 19 further comprising a user payment system, wherein the user payment includes at least one of a credit card account, a PayPal account, an apple pay account, a bank account, a bitcoin account, and their derivatives thereof.

29. The system for enabling interactive socialization of users at a venue as recited by claim 19 further comprising a wager system wherein users could place a wager in the wager system.

30. The system for enabling interactive socialization of users at a venue as recited by claim 19, wherein the communications includes at least one of text message, phone call, a voice mail, etc.

31. The system for enabling interactive socialization of users at a venue as recited by claim 19, wherein the compatibility match includes sports compatibility match, non-sports compatibility match, age compatibility match, sex compatibility match, professional interest compatibility match.
